(19) United States
(12) Patent Application Publication
(10) Pub. No.: US 2016/0249301 A1
(43) Pub. Date: Aug. 25, 2016

(54) Communication Method, Device for Dual-SIM Card-Dual-Call Terminal, and Dual-SIM Card-Dual-Call Terminal

(71) Applicant: ST-ERICSSON SA, Plan-les-Ouates (CH)

(72) Inventors: Jianfei XIAO, Beijing (CN); Jishui LI, Beijing (CN); Wei LIU, Beijing (CN)

(21) Appl. No.: 14/761,832

(22) PCT Filed: Feb. 22, 2015
(86) PCT No.: PCT/CN2013/071763

§ 371 Date: Jul. 23, 2015

(51) Int. Cl. H04W 52/22; H04W 52/24; H04W 72/04

(52) U.S. Cl. CPC H04W 52/221; H04W 72/0446; H04W 52/243

(57) ABSTRACT

A communication method, a communication device for a dual-SIM card-dual-call, DSDC, terminal, and the DSDC terminal are provided. The DSDC terminal includes a first radio frequency subsystem for initiating Packet Switching, PS, service and a second radio frequency subsystem for initiating Circuit Switching, CS, service. The transmission power for the PS service of the first radio frequency subsystem is controlled to be under a predetermined value during a reception timeslot for the CS service of the second radio frequency subsystem, thereby overcoming the problem caused by the interference between two radio frequency subsystems of the DSDC terminal.

### TECHNICAL FIELD

The present invention relates to the field of mobile telecommunication, in particular to a communication method, a device for a dual-SIM card-dual-call terminal, and the dual-SIM card-dual-call terminal.

### BACKGROUND

Usually, different wireless access technologies are used by different operators, and in this case one SIM (Subscriber Identity Module) card cannot use the network service provided by another operator if without altering the number of a mobile terminal. Therefore, there exists a need of a mobile terminal that supports a DSDC (Dual-SIM card-Dual-Call) function.

The mobile terminal with the DSDC function may support two SIM cards of different operators simultaneously, maintain to reside in the network and to be in a standby state. On the premise that the number of the mobile terminal is not switched, a mobile terminal user can use the network services provided by two operators and the mobile terminal can work in two different network modes simultaneously. Different from a DSDS (Dual-SIM card-Dual-Standby) terminal, the DSDC terminal can initiate or receive services in two mobile networks simultaneously, that is, one SIM card in the DSDC terminal when it is answering a call will not affect the other SIM card when it is browsing Internet or answering another call.

Usually, the DSDC terminal includes two independent radio frequency subsystems. In the prior art, the interference between the two radio frequency subsystems may be overcome by the methods such as antenna isolation or hardware/software optimization. However, these methods are of limited effectiveness in anti-interference, because it is very difficult to remove the noise on a reception frequency band thoroughly. In addition, if hardware optimization is adopted, additional frontend elements are required. As a result, not only the cost of the radio frequency subsystem is increased, but also the transmission performance and power consumption of the radio frequency subsystems will be inevitably attenuated due to the frontend elements (such as a band elimination filter).

### SUMMARY

The present invention aims to provide a communication method, a communication device for a DSDC terminal, and the DSDC terminal, so as to overcome the interference between two radio frequency subsystems of the DSDC terminal.

In order to solve the above-mentioned problem, the present invention, on one hand, provides a communication method for a DSDC terminal, the DSDC terminal includes a first radio frequency subsystem for initiating a Packet Switching (PS) service and a second radio frequency subsystem for initiating a Circuit Switching (CS) service, the communication method comprising:

controlling transmission power for the PS service of the first radio frequency system below a predetermined value within a reception timeslot for the CS service of the second radio frequency subsystem.

Further, prior to controlling transmission power for the PS service of the first radio frequency system below the predetermined value, the communication method comprises:

setting a correspondence between a reception level for the CS service and a transmission power threshold for the PS service.

Further, the controlling transmission power for the PS service of the first radio frequency system below the predetermined value comprises:

acquiring a reception level for the CS service, and determining a threshold for the PS service corresponding to the reception level in accordance with the correspondence; and

adjusting transmission power for the PS service, and controlling the transmission power for the PS service below the threshold.

Further, the adjusting transmission power for the PS service, and controlling the transmission power for the PS service below the threshold comprises:

judging whether current transmission power for the PS service is greater than the threshold; and

adjusting the transmission power for the PS service to be not greater than the threshold when the current transmission power for the PS service is greater than the threshold, and not adjusting the transmission power for the PS service when the current transmission power for the PS service is not greater than the threshold.

Further, the controlling transmission power for the PS service of the first radio frequency system below the predetermined value comprises:

cutting off the transmission power output for the PS service of the first radio frequency subsystem.

The present invention further provides a communication device for a DSDC terminal, the DSDC terminal includes a first radio frequency subsystem for initiating a PS service and a second radio frequency subsystem for initiating a CS service, the communication device comprising:

a controlling module, configured to control transmission power for the PS service of the first radio frequency subsystem below a predetermined value within a reception timeslot for the CS service of the second radio frequency subsystem.

Further, the communication device comprises:

a setting module, configured to set a correspondence between a reception level for the CS service and a transmission power threshold for the PS service.

Further, the controlling module comprises:

an acquiring submodule, configured to acquire a reception level for the CS service, and determine a threshold for the PS service corresponding to the reception level in accordance with the correspondence set by the setting module; and

a controlling submodule configured to adjust transmission power for the PS service, and control the transmission power for the PS service below the threshold.

Further, the controlling submodule comprises:

a judging unit, configured to judge whether current transmission power for the PS service is greater than the threshold; and

a processing unit, configured to adjust the transmission power for the PS service to be not greater than the threshold when the current transmission power for the PS service is greater than the threshold, and not to adjust the transmission power for the PS service when the current transmission power for the PS service is not greater than the threshold.

Further, the controlling module comprises:

a cutting-off submodule, configured to cut off the transmission power output for the PS service of the first radio frequency subsystem.

The present invention further provides a DSDC terminal comprising the above-mentioned communication device.

The present invention has the following beneficial effects. According to the present invention, the CS service needs to be at a higher priority in any case, and the PS service adopts a retransmission mechanism, thus the transmission power for the PS service may be controlled below a predetermined value within the reception timeslot for the CS service, so as to ensure that the CS service is not affected by the PS service. According to the present invention, it is able to ensure the performance of the CS service in the case of not affecting the user experience, thereby to achieve the coexistence of the PS service and the CS service.

### BRIEF DESCRIPTION OF THE DRAWINGS

FIG. 1 is a structural schematic view showing a DSDC terminal according to embodiments of the present invention;

FIG. 2 is a schematic view showing a correspondence between a reception level for a CS service and a transmission power threshold for a PS service according to embodiments of the present invention;

FIG. 3 is a schematic view showing the timeslots under a GSM mode and a WCDMA mode according to first embodiment of the present invention;

FIG. 4 is a schematic view showing the timeslots under a GSM mode and a WCDMA mode according to second embodiment of the present invention;

FIG. 5 is a flow chart of a communication method for a DSDC terminal according to first embodiment of the present invention; and

FIG. 6 is a flow chart of a communication method for a DSDC terminal according to second embodiment of the present invention.

### DETAILED DESCRIPTION

In order to make the technical problems to be solved by the present invention, the technical solutions and the advantages more apparent, the present invention is described in details in conjunction with the drawings and the embodiments.

Embodiments of the prevent invention provide a communication method and a communication device for a DSDC terminal, and the DSDC terminal so as to overcome the interference between two radio frequency subsystems of the DSDC terminal.

The DSDC terminal includes a first radio frequency subsystem for initiating a PS service and a second radio frequency subsystem for initiating a CS service. The communication method comprises:

controlling transmission power for the PS service of the first radio frequency subsystem below a predetermined value within a reception timeslot for the CS service of the second radio frequency subsystem.

In any case, the CS service needs to be at a higher priority, and the PS service adopts a retransmission mechanism, thus the transmission power for the PS service is controlled below the predetermined value within the reception timeslot for the CS service, so as to ensure that the CS service is not affected by the PS service. According to the present invention, it is able to ensure the performance of the CS service in the case of not affecting the user experience, thereby to achieve the coexistence of the PS service and the CS service.

Embodiments of the present invention further provide a communication device for a DSDC terminal including a first radio frequency subsystem for initiating a PS service and a second radio frequency subsystem for initiating a CS service. The communication device comprises:

a controlling module, configured to control transmission power for the PS service of the first radio frequency subsystem below a predetermined value within a reception timeslot for the CS service of the second radio frequency subsystem.

Further, the communication device comprises:

a setting module, configured to set a correspondence between a reception level for the CS service and a transmission power threshold for the PS service.

Further, the controlling module comprises:

an acquiring submodule configured to acquire the reception level for the CS service, and determine the threshold for the PS service corresponding to the reception level in accordance with the correspondence set by the setting module; and

a controlling submodule configured to adjust transmission power for the PS service and control the transmission power for the PS service below the threshold.

Further, the controlling submodule comprises:

a judging unit, configured to judge whether current transmission power for the PS service is greater than the threshold; and

a processing module, configured to adjust the transmission power for the PS service to be not greater than the threshold when the current transmission power for the PS service is greater than the threshold, and not to adjust the transmission power for the PS service any more when the current transmission power for the PS service is not greater than the threshold.

Further, the controlling module comprises:

a cutting-off submodule, configured to cut off the transmission power output for the PS service of the first radio frequency subsystem.

In any case, the CS service needs to be at a higher priority, and the PS service adopts a retransmission mechanism, thus the transmission power for the PS service is controlled below the predetermined value within the reception timeslot for the CS service, so as to ensure that the CS service is not affected by the PS service. According to the present invention, it is able to ensure the performance of the CS service in the case of not affecting the user experience, thereby to achieve the coexistence of the PS service and the CS service.

Embodiments of the present invention further provide a DSDC terminal comprising the above-mentioned communication device.

As shown in FIG. 1, the DSDC terminal includes two radio frequency subsystems, i.e., a radio frequency subsystem A that is connected to the PS service and the CS service and includes a modem A, a power amplifier, a radio frequency module A and an antenna, and a radio frequency subsystem B that is merely connected to the CS service and includes a modem B, a power amplifier, a radio frequency module B and an antenna. If the radio frequency subsystems work in the same timeslot, one of the radio frequency subsystems may obviously interfere with the other. As a result, call drop will occur and the establishment of a call will fail.

In the DSDC terminal, the interference is caused by the transmission power leakage of an interference source to an antenna port of an object to be interfered. If the power for the interference source can be limited to a certain extent, the performance of the radio frequency subsystem of the object to be interfered will not be affected. For the DSDC terminal, the PS service, which adopts a retransmission mechanism, is of the reliability better than the CS service, and the CS service is of a priority higher than the PS service. In the present invention, a transmission power backoff mechanism is applied to the PS service, so as to control the transmission power for the PS service below the predetermined value within the reception timeslot for the CS service. As a result, it able to ensure that the CS service is not affected by the PS service, and to ensure the performance of the CS service, thereby to achieve the coexistence of the PS service and the CS service.

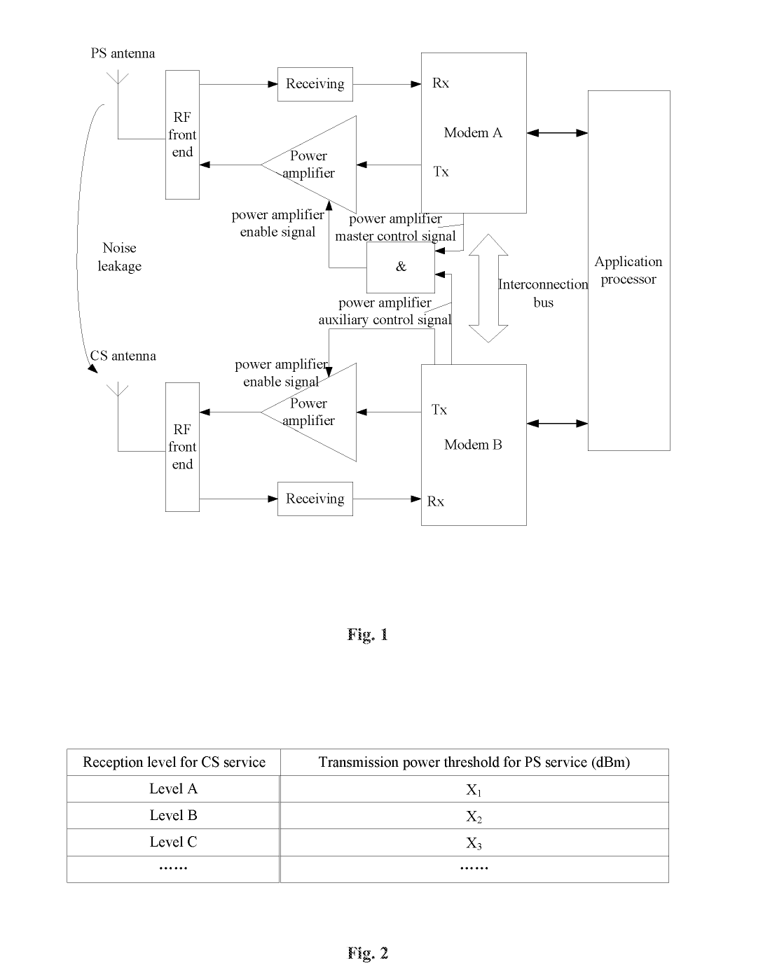

According to the embodiment of the present invention, a power backoff look-up table as shown in FIG. 2 is preset in the DSDC terminal, in which a correspondence between a reception level (RX level) for the CS service and a transmission power threshold for the PS service is set. Through this look-up table, it is able to obtain a clear guide about how to adjust the transmission power for the PS service in accordance with the reception level for the CS service. The look-up table not only provides the correspondence between the transmission power for the PS service and the reception level for the CS service, but also includes the operating band information. The transmission power threshold for the PS service in the look-up table is determined by the platform link budget and the coexistence test result at a receiver. The transmission power threshold for the PS service in the look-up table may be adjusted based on the different platform radio frequency characteristics, and each of the frequency band groups for the DSDC terminal shall have a corresponding look-up table. For example, WCDMA Band I has a look-up table corresponding to GSM DCS1800, and a look-up table corresponding to GSM900. For the DSDC terminals of the same kind, the contents in the look-up table are predefined and do not need calibration.

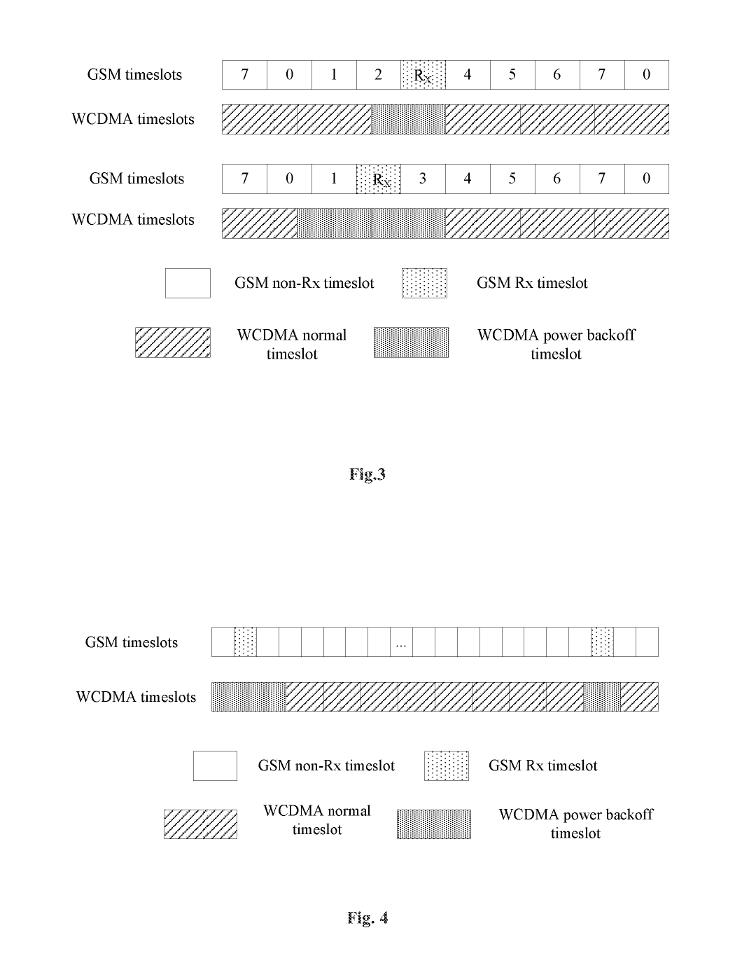

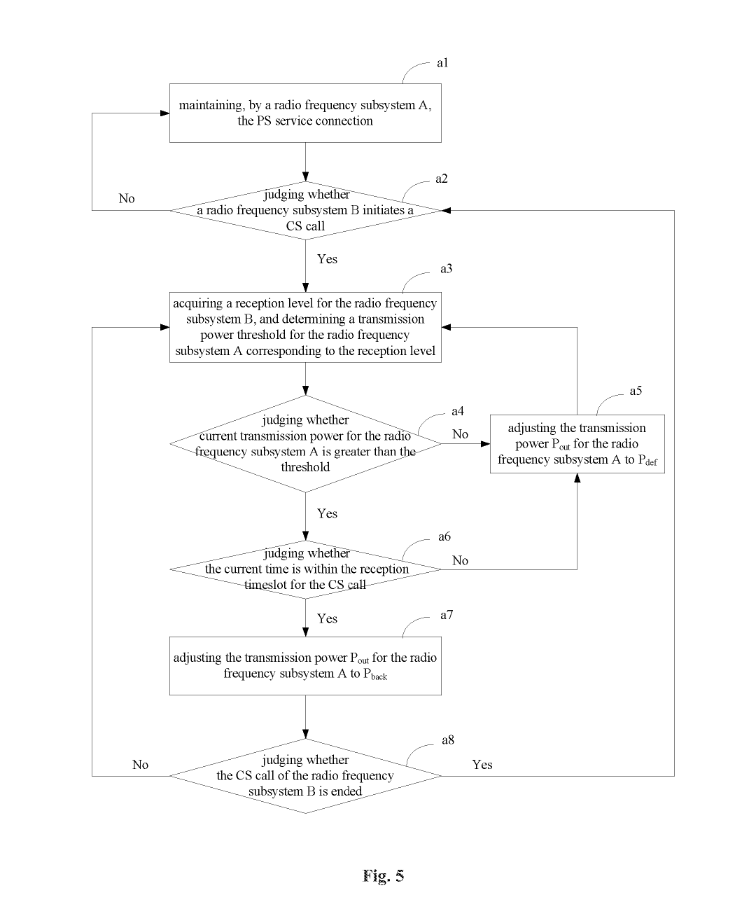

Prior to adjusting the transmission power for the PS service, at first it needs to know the current reception level for the CS service, and the parameters can be obtained from the network measurement result at the DSDC terminal. The radio frequency subsystem A of the DSDC terminal can acquire the reception level for the CS service of the radio frequency subsystem B via an interconnection bus or an application processor. To be specific, a power backoff mechanism is applied to the PS service within the reception timeslot for the CS service. FIGS. 3 and 4 show the relationship between the GSM reception timeslot and the WCDMA power backoff timeslot under the power backoff mechanism by taking a DSDC terminal operating at the GSM and WCDMA modes as an example. As can be seen from FIGS. 3 and 4, within one or two WCDMA timeslots corresponding to the GSM reception timeslot, the transmission power for the PS service is affected by the power backoff mechanism.

According to embodiments of the present invention, the transmission power for the PS service may be adjusted on the basis of the following criterion. When the current transmission power for the PS service is not greater than the transmission power threshold corresponding to the current reception level for the CS service, Pₒᵤₜ=P_{def}, and when the current transmission power for the PS service is greater than the transmission power threshold corresponding to the current reception level for the CS service, Pₒᵤₜ=P_{back}. P_{def} represents a default power output value determined in accordance with the system and the power control mechanism, and it is variable based on different power levels. P_{back} represents an output power value selected from the power backoff look-up table, and it corresponds to the reception level for the CS service. Through the above criterion, it is able to limit the transmission power for the PS service to be within a relatively low range.

Further, apart from the above method of adjusting the transmission power for the PS service through software, the transmission power for the PS service may also be adjusted through hardware, i.e., by cutting off the transmission of the PS service within the reception timeslot for the CS service. As shown in FIG. 1, a dedicated GPIO (General Purpose Input Output) interface is connected to an enable pin of a power amplifier via an AND gate, and an enable signal to be outputted to a PS power amplifier may be cut off within the reception timeslot for the CS service by changing a level of a power amplifier master control signal outputted by the modem A or a level of a power amplifier auxiliary control signal outputted by the modem B, so as to eliminate the interference from the radio frequency subsystem A. As compared to the method of controlling the transmission power for the PS service through software, the method of controlling the transmission power for the PS service through hardware is simpler to be implemented.

The communication method for a DSDC terminal according to the present invention will be described hereinafter in conjunction with the embodiments.

### First Embodiment

In this embodiment, the radio frequency subsystem A maintains the PS service connection, while the radio frequency subsystem B is initiating a CS call.

As shown in FIG. 5, the communication method for a DSDC terminal comprises the following steps.

Step a1: maintaining, by a radio frequency subsystem A, the PS service connection.

Step a2: judging whether a radio frequency subsystem B initiates a CS call, if yes, turning to Step a3, and otherwise returning to Step a1.

Step a3: acquiring a reception level for the radio frequency subsystem B, and determining a transmission power threshold for the radio frequency subsystem A corresponding to the reception level. To be specific, the radio frequency subsystem A can acquire the reception level for the CS service of the radio frequency subsystem B via an interconnection bus or an application processor, and determine the transmission power threshold for the radio frequency subsystem corresponding to the reception level by looking up a power backoff look-up table.

Step a4: judging whether current transmission power for the radio frequency subsystem A is greater than the threshold, if yes, turning to Step a6, and otherwise, turning to Step a5.

Step a5: adjusting the transmission power Pₒᵤₜ for the radio frequency subsystem A to P_{def}, and turning to Step a3. To be specific, the transmission power Pₒᵤₜ of the radio frequency subsystem A may be adjusted to P_{def} by adjusting a power amplifier or a radio frequency module A of the radio frequency subsystem A.

Step a6: judging whether the current time is within the reception timeslot for the CS call, if yes, turning to Step a7, and otherwise turning to Step a5. To be specific, a power backoff mechanism is applied to the PS service within the timeslot for the CS service until the CS call is released.

Step a7: adjusting the transmission power Pₒᵤₜ for the radio frequency subsystem A to P_{back}. To be specific, the transmission power Pₒᵤₜ for the radio frequency subsystem A may be adjusted to P_{back} by adjusting the power amplifier or the radio frequency module A of the radio frequency subsystem A. P_{back} is not greater than the transmission power threshold corresponding to the reception level for the CS service. Further, the transmission power output for the radio frequency subsystem A may be cut off by adjusting a master control signal of the power amplifier outputted from the Modem A or an auxiliary control signal of the power amplifier outputted from the Modem B, and at this time, P_{back} has a value of 0.

Step a8: judging whether the CS call of the radio frequency subsystem B is ended, if yes, turning to Step a2, and otherwise turning to Step a3.

In this embodiment, the power backoff mechanism applied to the PS service may affect the PS service throughput, but as compared to the radio frequency interference on the CS service, the attenuation of the PS service throughput is very low, and the user experience will not be affected. For example, when the radio frequency subsystem B is initiating a CS call, the deterioration degree of the PS service throughput due to the power backoff mechanism, in the worst case, may be calculated by the following equation (where WCDMA PS and GSM CS are taken as an example, and in fact it is also compatible with the other wireless access technologies, such as TD-SCDMA and EDGE):

d%=2*0.666 ms/10 ms=13.3%,

wherein, d % is an attenuation percentage. The timeslot for WCDMA is 0.666 ms, so a WCDMA frame of 10 ms may include 15 timeslots. As shown in FIG. 3, at most two of these PS timeslots may be affected by the power backoff mechanism, and it is necessary to retransmit the data within the two PS timeslots.

### Second Embodiment

In this embodiment, the radio frequency subsystem A maintains a PS service connection, while the radio frequency subsystem B is in a sleep or idle state. In this case, it is required to ensure that the radio frequency subsystem B can receive the CS service at any time, even if the radio frequency subsystem B is in the sleep or idle state.

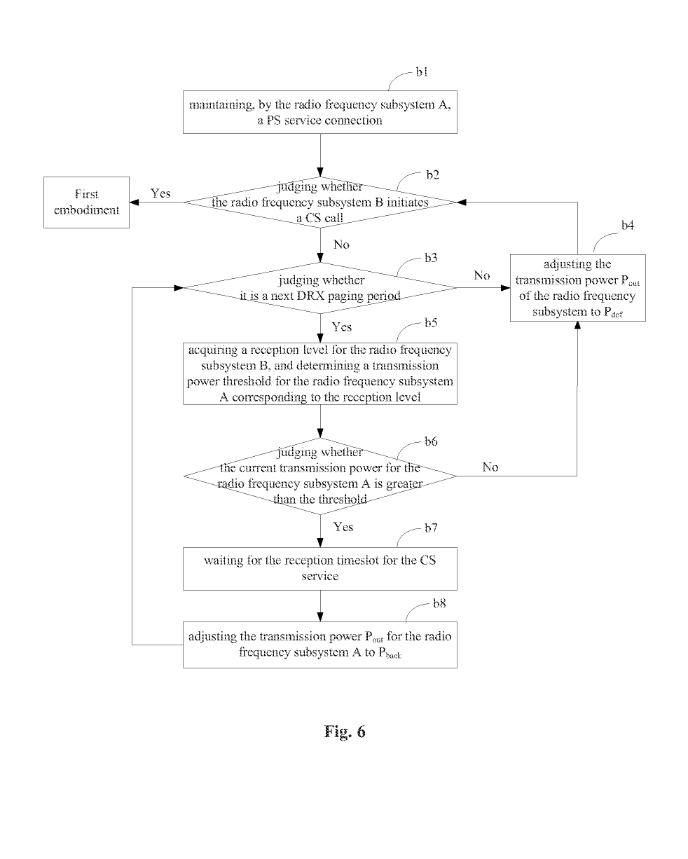

As shown in FIG. 6, the communication method according to this embodiment comprises the following steps.

Step b1: maintaining, by the radio frequency subsystem A, a PS service connection.

Step b2: judging whether the radio frequency subsystem B initiates a CS call, if yes, executing Steps a2-a8 as described in the first embodiment, and otherwise turning to Step b3.

Step b3: judging whether it is a next DRX (Discontinuous Reception) paging period, if yes, turning to Step b5, and otherwise turning to Step b4.

Similar to the first embodiment, the radio frequency subsystem A can acquire a reception level for the CS service, and a DRX paging period when the CS is in a standby state. The power backoff mechanism is applied to the PS service within the reception timeslot for the CS service according to the present invention, thus it is able to determine the reception timeslot for the CS service according to the DRX paging period of the CS service after acquiring the DRX paging period of the CS service, thereby to apply the power backoff mechanism to the PS service within the determined reception timeslot for the CS service. In addition, when the radio frequency subsystem B has received a CS call, the radio frequency subsystem B will exit the sleep or idle state, and Steps a2-a8 as described in the first embodiment will be performed subsequently.

Step b4: adjusting the transmission power Pₒᵤₜ of the radio frequency subsystem to P_{def}, and turning to Step b2. To be specific, the transmission power Pₒᵤₜ of the radio frequency subsystem A may be adjusted to P_{def} by adjusting a power amplifier or a radio frequency module A of the radio frequency subsystem A.

Step b5: acquiring a reception level for the radio frequency subsystem B, and determining a transmission power threshold for the radio frequency subsystem A corresponding to the reception level. To be specific, the radio frequency subsystem A may acquire the reception level for the CS service of the radio frequency subsystem B via an interconnection bus or an application processor, and determine the transmission power threshold for the radio frequency subsystem A corresponding to the reception level by looking up a power backoff look-up table.

Step b6: judging whether the current transmission power for the radio frequency subsystem A is greater than the threshold, if yes, turning to Step b7, and otherwise turning to Step b4.

Step b7: waiting for the reception timeslot for the CS service.

Step b8: adjusting the transmission power Pₒᵤₜ for the radio frequency subsystem A to P_{back}, and turning to Step b3. To be specific, the transmission power Pₒᵤₜ for the radio frequency subsystem may be adjusted to P_{back} by adjusting the power amplifier or the radio frequency module A of the radio frequency subsystem A, and P_{back} is not greater than the transmission power threshold corresponding to the reception level for the CS service.

Further, the transmission power output for the radio frequency subsystem A may be cut off by adjusting a master control signal of the power amplifier outputted from the Modem A or an auxiliary control signal of the power amplifier outputted from the Modem B, and at this time, P_{back} has a value of 0.

In this embodiment, the power backoff mechanism applied to the PS service may affect the PS service throughput, but as compared to the radio frequency interference on the CS service, the attenuation of the PS service throughput is very low, and the user experience will not be affected. For example, when the radio frequency subsystem B is in the sleep or idle state, the deterioration degree of the PS service throughput due to the power backoff mechanism, in the worst case, may be calculated by the following equation (where WCDMA PS and GSM CS are taken as an example, and in fact it is also compatible with the other wireless access technologies, such as TD-SCDMA and EDGE):

d%=2*0.666 ms/4.615 ms*51*2=0.28%,

wherein, d % is an attenuation percentage. The timeslot for WCDMA is 0.666 ms and the timeslot for GSM is 4.615 ms, so a GSM superframe includes 51 frames. As shown in FIG. 4, in the worst case where DRX=2, at most two PS timeslots may be affected by the power backoff mechanism, and it is necessary to retransmit the data within the two PS timeslots.

The above first and second embodiments relate to the condition where the radio frequency subsystem A maintains the PS service connection. In addition, under the condition where the radio frequency subsystem B maintains the CS service connection while the radio frequency subsystem A is in an idle or sleep state but is to establish the PS service connection, the power backoff mechanism as described in the first embodiment may be applied once the radio frequency subsystem A has successfully established the PS service connection. It is to be noted that, the PS service connection must be established outside the reception timeslot for the CS service.

Any DSDC terminal, including but not limited to a terminal with the DSDC radio frequency configuration of WCDMA/GSM+GSM, TD-SCDMA/GSM+GSM, CDMA2000+GSM or GSM+GSM, may adopt the power backoff mechanism as described in the present invention. According to the present invention, it is able to ensure the performance of the CS service without affecting the user experience, thereby to achieve the coexistence of the PS service and the CS service. As compared to the existing DSDC terminal, it is merely required to add an AND gate in the present invention, without causing any additional cost in hardware for the mobile terminal manufacturer.

The functional members described in the specification are referred to as modules, so as to emphasize the independence of the implementation in a more particular manner.

According to the embodiments of the present invention, the modules may be implemented by software, so as to be executed by various processors. For example, an identified, executable code module may comprise one or more physical or logical blocks including computer instructions, and the module can be constructed as an image, a process or a function. Even so, the executable codes of the identified modules are unnecessary to be physically located together, but may comprise different instructions stored in different locations. When these instructions are logically combined together, they form the modules and achieve the prescribed purposes of the modules.

Actually, the executable code module may be a single instruction or a plurality of instructions, and can even be distributed at different code segments, in different programs, or across a plurality of memory devices. Also, operational data may be identified in the modules, implemented in any appropriate form, and organized in any data structure of an appropriate type. The operational data may be collected as a single data set, or distributed at different locations (including different memory devices), and may be at least partially present in a system or network merely as an electronic signal.

When the modules can be implemented by software, considering the current hardware level, a person skilled in the art can build a corresponding hardware circuit to achieve the corresponding function if taking no account of the cost. The hardware circuit comprises a conventional very-large-scale integration (VLSI) circuit, a gate array, an existing semiconductor such as a logic chip and a transistor, or other discrete components. The modules may further be implemented by a programmable hardware device, such as a field-programmable gate array, a programmable array logic device and a programmable logic device.

The above are merely the embodiments of the present invention. It should be noted that, a person skilled in the art may further make improvements and modifications without departing from the principle of the present invention, and these improvements and modifications shall also be considered as the scope of the present invention.

1. A communication method for a Dual-SIM card-Dual-Call terminal, the Dual-SIM card-Dual-Call terminal includes a first radio frequency subsystem for initiating a Packet Switching, PS, service and a second radio frequency subsystem for initiating a Circuit Switching, CS, service, the communication method comprising:
controlling a transmission power for the PS service of the first radio frequency subsystem to be under a predetermined value during a reception timeslot for the CS service of the second radio frequency subsystem.

2. The communication method according to claim 1,
wherein prior to the controlling of the transmission power for the PS service of the first radio frequency subsystem under the predetermined value, the method further comprises:
setting a correspondence between a reception level for the CS service and the predetermined value, which is a transmission power threshold for the PS service.

3. The communication method according to claim 2,
wherein the controlling of the transmission power for the PS service of the first radio frequency subsystem under the predetermined value comprises:
acquiring the reception level for the CS service, and determining the threshold for the PS service corresponding to the reception level in accordance with the correspondence; and
adjusting the transmission power for the PS service so that the transmission power for the PS service to be below the threshold.

4. The communication method according to claim 3, wherein the adjusting of the transmission power for the PS service comprises:
judging whether a current transmission power for the PS service is greater than the threshold; and
adjusting the transmission power for the PS service to be not greater than the threshold when the current transmission power for the PS service is greater than the threshold, and not adjusting the transmission power for the PS service when the current transmission power for the PS service is not greater than the threshold.

5. The communication method according to claim 1, wherein the controlling of the transmission power for the PS service of the first radio frequency system to be below the predetermined value comprises:
cutting off the transmission power output for the PS service of the first radio frequency subsystem.

6. A communication device for a dual-SIM card-dual-call terminal, the Dual-SIM card-Dual-Call terminal includes a first radio frequency subsystem for initiating a PS service and a second radio frequency subsystem for initiating a CS service, the communication device comprising:
a controlling module configured to control a transmission power for the PS service of the first radio frequency subsystem to be below a predetermined value within a reception timeslot for the CS service of the second radio frequency subsystem.

7. The communication device according to claim 6, wherein the communication device further comprises:
a setting module configured to set a correspondence between a reception level for the CS service and the predetermined value, which is a transmission power threshold for the PS service.

8. The communication device according to claim 7, wherein the controlling module comprises:
an acquiring submodule configured to acquire the reception level for the CS service, and to determine the threshold for the PS service corresponding to the reception level in accordance with the correspondence set by the setting module; and
a controlling submodule configured to adjust the transmission power for the PS service, so that the transmission power for the PS service to be below the threshold.

9. The communication device according to claim 8, wherein the controlling submodule comprises:
a judging unit configured to judge whether a current transmission power for the PS service is greater than the threshold; and
a processing unit, configured to adjust the transmission power for the PS service to be not greater than the threshold when the current transmission power for the PS service is greater than the threshold, and not to adjust the transmission power for the PS service when the current transmission power for the PS service is not greater than the threshold.

10. The communication device according to claim 6, wherein the controlling module comprises:
a cutting-off submodule configured to cut off the transmission power output for the PS service of the first radio frequency subsystem.

11. A dual-SIM card-dual-call terminal, comprising:
a communication device including a controlling module for a dual-SIM card-dual-call terminal, the Dual-SIM card-Dual-Call terminal having a first radio frequency subsystem for initiating a PS service and a second radio frequency subsystem for initiating a CS service,
wherein the controlling module is configured to control a transmission power for the PS service of the first radio frequency subsystem to be below a predetermined value within a reception timeslot for the CS service of the second radio frequency subsystem.
